(19) United States
(12) Patent Application Publication
(10) Pub. No.: US 2006/0207374 A1
(43) Pub. Date: Sep. 21, 2006

(54) Handlebar-mounted control lever

(76) Inventor: Robert L. Barnett, Santa Ana, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/366,119

(22) Filed: Mar. 2, 2006

Related U.S. Application Data
(60) Provisional application No. 60/658,016, filed on Mar. 2, 2005.

(51) Int. Cl. G05G 11/00

(52) U.S. Cl. 74/488

(57) ABSTRACT

A control lever includes a lever blade portion and a mounting portion. The mounting portion includes an aperture defining a pivot axis and configured to permit the control lever to be supported relative to a lever perch. The mounting portion of the lever includes a lever stop defining a stop surface for contacting a perch stop of the perch and establishing a released position of the control lever relative to the perch. At least one of the lever stop and the perch stop includes a wedge surface configured to define a clearance space between the mounting portion of the lever and the perch.

### RELATED APPLICATIONS

This application is related to, and claims priority from, U.S. Provisional Patent Application No. 60/658,016, filed Mar. 2, 2005, the entirety of which is incorporated by reference herein and made a part of the present disclosure.

### BACKGROUND OF THE INVENTION

1. Field of the Invention

The present invention relates to handlebar-mounted control levers for vehicles. More particularly, the present invention relates to a control lever configured to operate effectively in muddy conditions.

2. Description of the Related Art

Control levers for use with vehicles having a handlebar steering mechanism are typically supported relative to the handlebar by a mounting structure, or “perch.” The control levers may be used to control various systems of the vehicle, such as the clutch, brake, or hot-start systems, for example. The perch has upper and lower flanges that define a space therebetween configured to receive a mounting portion of the control lever. Typically, a bolt passes through apertures in both the perch and the control lever to rotatably support the control lever relative to the perch. The lever includes a blade portion extending from the mount portion. The blade portion is configured to provide a hand-grip area so that a user may pull the control lever toward the handlebar using one or more fingers.

The control lever includes a stop defining a stop surface that is configured to contact a corresponding stop surface of the perch when the control lever is in a relaxed position. Typically, the stop surface of the lever extends substantially the entire distance between the upper and lower flanges of the perch such that little, if any, space remains between the upper flange of the perch and the upper surface of the control lever stop or between the lower flange of the perch and the lower surface of the control lever stop. In addition, the stop surface usually contacts the perch along a significant distance in a direction generally perpendicular to the axis of rotation of the control lever or, in other words, in a direction extending inward, toward the pivot bolt, from a forward surface of the perch.

When the control lever is rotated toward the handlebar, a space is created between the stop surface of the lever and the corresponding stop surface of the perch, and is bounded by the upper and lower flanges of the perch. However, as described above, the mounting portion of the lever occupies substantially the entire space between the upper and lower flanges of the perch when the lever is in a relaxed position. As a result, the prior art control levers are ineffective at expelling viscous matter, such as mud for example, from between the control lever and the perch. When the vehicle is operated during muddy conditions, mud may enter the space between the mounting portion of the lever and the perch when the lever is rotated toward the handlebar. Upon release of the lever, the mud may interfere with movement of the lever toward the relaxed position. For example, the mud may slow the movement of the lever, or prevent the control lever from moving back to the relaxed position. If the control lever is arranged to control the brake system, for example, the brakes may become “locked-up” or stuck in an actuated position.

### SUMMARY OF THE INVENTION

Preferred embodiments of the present control lever are configured to urge viscous material, such as mud, from the space between the stop surface of the control lever and the corresponding stop surface of the lever perch. Thus, the preferred embodiments are less likely to become inoperable due to jamming with mud. In one preferred embodiment, the control lever stop is generally V-shaped to create a wedge to provide a space to accommodate viscous material and, preferably, to urge the viscous material out of the space between the control lever stop and the perch. In another arrangement, the wedge may be provided on the perch, in addition to or alternative to a wedge on the lever.

A preferred embodiment is a control lever includes a lever blade portion and a mounting portion. The mounting portion includes an aperture defining a pivot axis and configured to permit the control lever to be supported relative to a lever perch. The mounting portion includes a stop defining a stop surface for contacting the perch and establishing a released position of the control lever relative to the perch. The stop includes a wedge extending from the stop surface.

### BRIEF DESCRIPTION OF THE DRAWINGS

These and other features, aspects and advantages of the present control lever are described below with reference to drawings of a preferred embodiment, which is intended to illustrate but not to limit the present invention. The drawings contain five (5) figures.

FIG. 1 is a perspective view of a control lever and mounting perch, which incorporates a front brake master cylinder in the illustrated embodiment.

FIG. 2 is an enlarged view of a stop portion of the control lever and a corresponding surface of the perch with the lever in a relaxed position relative to the perch, The stop of FIG. 2 represents an example of a prior art lever stop arrangement.

FIG. 3 is the enlarged view of the prior art stop arrangement of FIG. 2 with the lever in an actuated position thereby creating an open space between the lever stop and perch.

FIG. 4 is a view of the mounting portion of one embodiment of the present invention including surface features configured to urge mud from between the control lever stop and the perch.

FIG. 5 is another view of the mounting portion of FIG. 4, looking directly toward the stop surface.

FIGS. 6A and 6B are views of the mounting portion of FIGS. 4 and 5 shown abutting a perch. FIG. 6A is a front view of the lever and perch assembly. FIG. 6B is a cross-sectional view, looking from above the lever and perch assembly, taken along view line 6B-6B of FIG. 6A.

### DETAILED DESCRIPTION OF THE PREFERRED EMBODIMENT

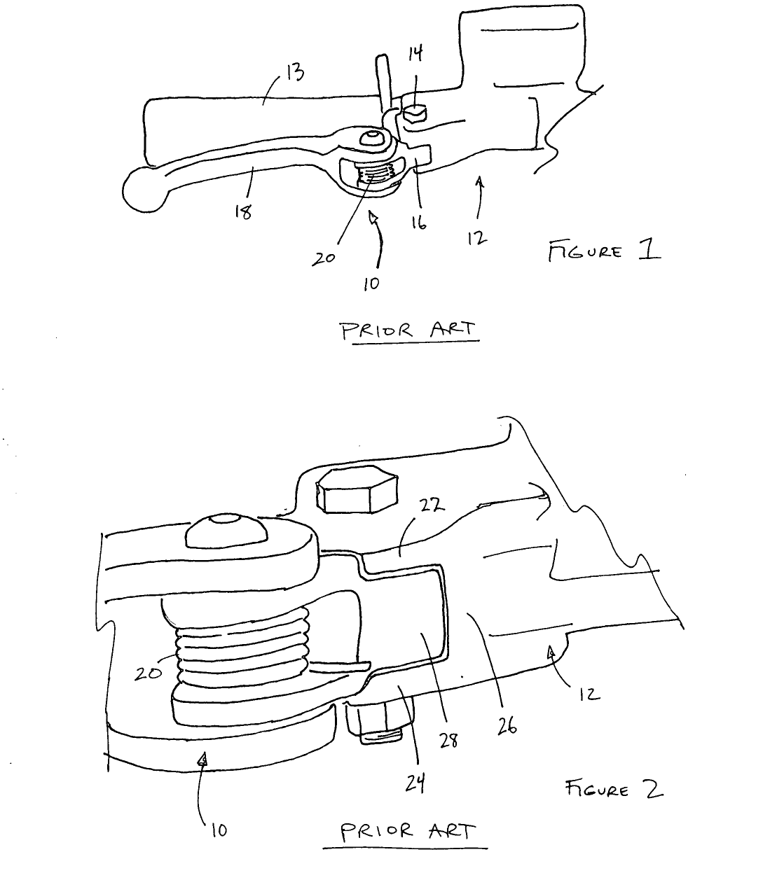

FIGS. 1-3 illustrate a control lever 10 rotatably mounted relative to a lever perch 12. The perch 12 is mountable to a vehicle handlebar 13 such that the lever 10 may be actuated by one or more fingers of a user grasping the handlebar 13. Preferably, a shaft, such as a shaft portion of a bolt 14, passes through both the perch 12 and the control lever 10 to rotatably support the lever 10 relative to the perch 12. The illustrated perch 12 incorporates a front brake master cylinder and, thus, the control lever 10 is configured to control the front brake system of an associated vehicle, such as a motorcycle, all-terrain vehicle (atv), snowmobile or the like, preferably by selectively applying a force to a hydraulic piston (not shown).

The illustrated lever 10 is a collapsible lever intended to inhibit damage in the event of a fall or crash. Thus, preferably, the lever 10 includes a mount portion 16 and a blade portion 18, which are rotatable relative to one another. The blade portion 18 is rotatable, against the force of biasing spring 20, to a collapsed position (rotates counter-clockwise in FIG. 1) to inhibit breakage of the lever 10. Preferred embodiments of such a collapsible lever 10 are described in greater detail in Applicant's U.S. Pat. Nos. 6,393,936 and 6,578,445, each entitled “COLLAPSIBLE CONTROL LEVER,” the entireties of which are incorporated by reference herein. However, if desired, other suitable lever constructions, including a lever construction wherein the blade and mount portion are rigidly connected, or are a unitary structure, may also be used.

The perch 12 includes an upper flange 22, a lower flange 24 and a perch stop 26 defining a stop surface. The mount portion 16 of the control lever 10 is received between the upper and lower flanges 22, 24 and includes a lever stop 28 defining a stop surface configured to contact the stop surface of the perch stop 26 to establish a released position, or relaxed position of the lever 10.

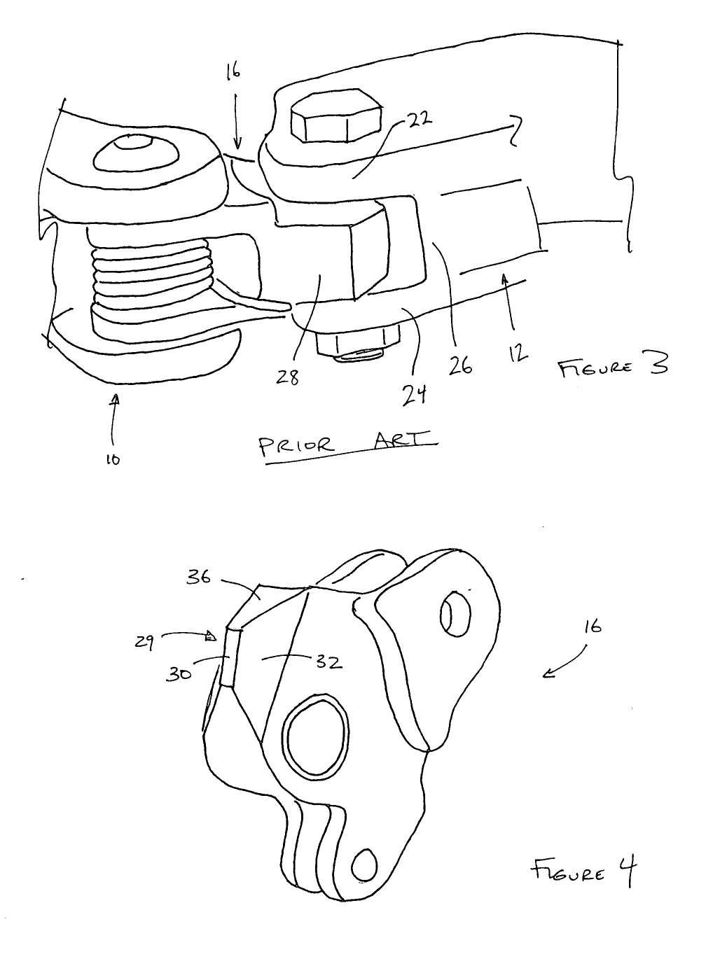

As illustrated in FIG. 2, in a relaxed position, the lever stop 28 occupies substantially the entire space between the upper flange 22 and the lower flange 24 of the perch 12. With reference to FIG. 3, when the lever 10 is moved toward its actuated position (toward the handlebar 13 or clockwise in FIG. 1), an open space S is created between the lever stop 28 and the perch stop 26. As discussed above, in muddy conditions, mud can enter the open space and interfere with movement of the lever 10 toward the relaxed position (i.e., toward the perch stop 26). As a result, movement of the lever 10 toward the relaxed position may be slowed, or the lever 10 may be prevented from moving all the way to the relaxed position. This problem may be exacerbated during competition events, where one vehicle may closely follow another vehicle and be subjected to significant amounts of dirt and mud projected in a rearward direction from the driven wheel(s) of the lead vehicle.

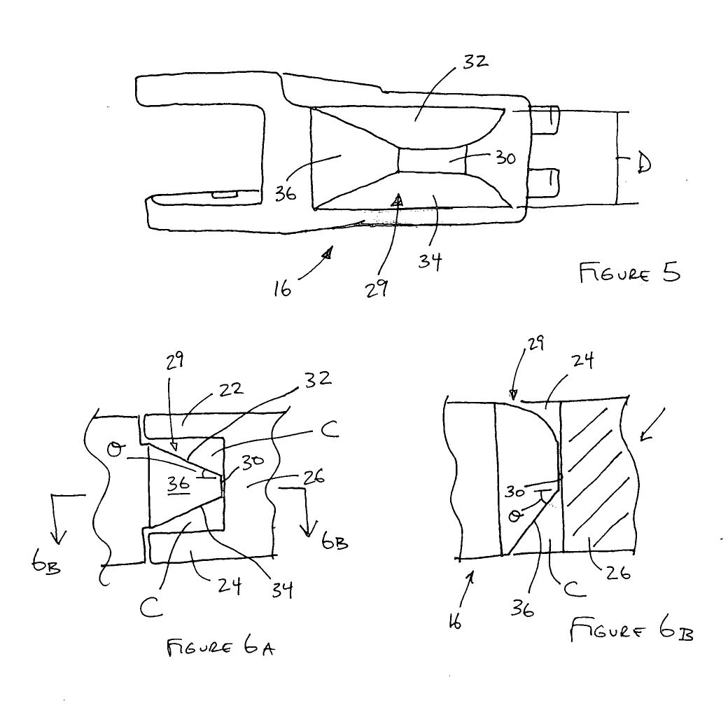

FIGS. 4 and 5 illustrate a mount portion 16 of a control lever 10 having certain features, aspects and advantages of the present invention. Although the illustrated mount portion 16 is configured for use with a separate blade portion 18 to create a collapsible lever 10, the features, aspects and advantages of the lever 10 described herein may be employed in connection with a conventional, rigid lever as well.

The mount portion 16 of FIGS. 4 and 5 incorporates a wedge-shaped stop 29 to create a space between the lever stop 29 and the perch stop 26 (and, preferably, the upper and lower flanges 22, 24) to accommodate mud or other viscous debris, while still allowing the lever 10 to move to its relaxed position. Preferably, the wedge shape tends to urge mud out of the space between the lever stop 29 and the perch stop 26.

The illustrated lever stop 29 includes a stop surface 30 configured to contact the stop surface of the perch stop 26. Desirably, a first wedge surface 32, a second wedge surface 34 and a third wedge surface 36 each extend from the stop surface 30. The first wedge surface 32 faces the upper flange 22 and the second wedge surface 34 faces the lower flange 24. The third wedge surface 36 faces the stop surface of the perch stop 26 and is canted away from the perch stop 26, as illustrated in FIG. 6B. Although such a structure is preferred to maximize the accommodation and/or movement of mud (or other viscous debris), other suitable structures may also be used. For example, only one wedge surface may be provided, and may face any one of the upper flange 22, lower flange 24 or perch stop 26.

In other arrangements, the structure forming the lever stop 29 may simply occupy less than the entire space between the perch flanges 22, 24 and, preferably, significantly less than the entire space, without having a wedge shape. Thus, in such an arrangement, enhancing the accommodation of mud may be preferred over attempting to urge mud out of the space between the lever 10 and the perch 12.

In the illustrated arrangement, the stop surface 30 preferably has a significantly smaller surface area than the available surface area of the perch stop 26 to provide a clearance space C between the lever 10 and the perch 12 to accommodate an accumulation of mud or other viscous material, as illustrated in FIGS. 6A and 6B. In the illustrated arrangement, the lever stop 29 defines a maximum dimension D between the upper surface 32 and lower surface 34 at their maximum spaced distance from one another, as illustrated in FIG. 5. In the illustrated arrangement, the maximum dimension D is measured along a line extending generally parallel to an axis of rotation of the lever 10 and parallel to the stop surface 30. Preferably, a height of the stop surface 30 is less than about one-half the maximum dimension D and, more preferably, is less than about one-third of the maximum dimension D. Further, in many specific instances, the maximum dimension D will be similar to the distance between the upper flange 22 and lower flange 24 of a cooperating perch 12. Assuming such, preferably, a height of the stop surface 30 is also less than about one-half the distance between the upper flange 22 and lower flange 24 of the perch 12 and, more preferably, is less than about one-third of the distance between the upper and lower flanges 22, 24.

In the illustrated arrangement, the stop surface 30 is spaced from both the upper flange 22 and the lower flange 24 and, specifically, is spaced approximately equidistant from the flanges 22, 24. Further, as illustrated in FIG. 6B, the stop surface 30 is spaced rearward of a forward edge (lower edge in FIG. 6B) of the perch stop 26. However, in alternative arrangements, the stop surface 30 may be located closer to one of the flanges 22, 24 than the other, including adjacent one of the flanges 22, 24. Furthermore, if desired, a forward end of the stop surface 30 may be closer to the forward edge of the perch stop 26 than illustrated in FIG. 6B or approximately flush with the forward end of the stop surface 30.

Desirably, the wedge surfaces 32, 34, 36 are generally planar and define an acute angle θ relative to a plane generally perpendicular to the stop surface 30. In one arrangement, an angle θ between any one of the surfaces 32, 34, 36 and a plane perpendicular to the stop surface 30 is about 15 degrees. However, other suitable angles may also be used. Preferably, the wedge surfaces 32, 24, 26 are configured to urge mud out of the space between the lever stop 29 and perch stop 26 when the lever 10 moves toward the relaxed position, thereby maintaining the effective operation of the lever 10, even in muddy conditions. Although planar wedge surfaces 32, 34, 36 have been shown, other types of surfaces, or relief sections, may also be used, including curved surfaces, for example.

In an alternative configuration, the perch stop 26 may be configured in a similar manner to the lever stop 29. That is, surfaces similar to the wedge surfaces 32, 34, 36 may be provided on the perch stop 26 instead of, or in addition to, the wedge surfaces 32, 34, 36 of the lever stop 29. However, because levers 10 are usually less expensive and more often replaced than lever perches 12, it is presently preferred to provide the clearance features, such as the wedge surfaces 32, 34, 36 on the lever 10. In some arrangements, the levers 10 may be sold separately from the perch 12, such as replacement or upgrade parts, for example. In other arrangements, the lever 10 and perch 12 may be sold as a kit and one or both of the lever 10 and perch 12 may include clearance features, such as surfaces similar to the wedge surfaces 32, 34, 36. Furthermore, the features, aspects and advantages of the present invention may be incorporated into other vehicle components that tend to become clogged with mud, as will be appreciated by those of skill in the art.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In particular, while the present control lever has been described in the context of a particularly preferred embodiment, the skilled artisan will appreciate, in view of the present disclosure, that certain advantages, features and aspects of the lever assembly may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A control lever, comprising:
a lever blade portion; and
a mounting portion including an aperture defining a pivot axis and configured to permit said control lever to be supported relative to a lever perch, said mounting portion including a stop defining a stop surface for contacting the perch and establishing a released position of said control lever relative to the perch;
wherein said stop comprises at least one wedge surface extending from said stop surface.

2. The control lever of claim 1, wherein said at least one wedge surface cooperates with the perch to create a space between said control lever and the perch adjacent said stop surface.

3. The control lever of claim 1, wherein said at least one wedge surface is configured to urge viscous debris out of said space when said control lever moves toward said released position.

4. The control lever of claim 1, wherein said stop defines a includes an upper surface and a lower surface and a maximum dimension is defined between said upper surface and said lower surface, wherein said stop surface defines a stop surface height that is less than or equal to about one-half of said maximum dimension.

5. The control lever of claim 4, wherein said stop surface height is less than or equal to about one-third of said maximum dimension.

6. The control lever of claim 1, wherein said at least one wedge surface comprises an upper wedge surface extending from said stop surface and a lower wedge surface extending from said stop surface.

7. A handlebar-mountable vehicle control kit, comprising:
a perch configured to be mountable to a vehicle handlebar;
a lever having a blade portion and a mounting portion, said mounting portion including an aperture defining a pivot axis and configured to permit said control lever to be supported relative to said perch, said mounting portion including a lever stop configured to contact a perch stop of the perch when the lever is in a released position relative to the perch;
wherein at least one of said lever stop and said perch stop comprises at least one wedge surface configured to create a clearance space between said lever stop and said perch stop when said lever is in said released position.

8. The kit of claim 7, wherein said at least one wedge surface is defined by said lever and cooperates with the perch to create said clearance space between said lever and the perch adjacent a stop surface of said lever that contacts said perch when said lever is in said released position.

9. The lever of claim 8, wherein said lever stop includes an upper surface and a lower surface and a maximum dimension is defined between said upper surface and said lower surface, wherein said stop surface defines a stop surface height that is less than or equal to about one-half of said maximum dimension.

10. The lever of claim 9, wherein said stop surface height is less than or equal to about one-third of said maximum dimension.

11. The kit of claim 8, wherein said at least one wedge surface is configured to urge viscous debris out of a space between said lever and said perch when said lever moves toward said released position.

12. The lever of claim 8, wherein said at least one wedge surface comprises an upper wedge surface and a lower wedge surface.

13. The kit of claim 7, wherein said at least one wedge surface is configured to urge viscous debris out of a space between said lever and said perch when said lever moves toward said released position.

14. The lever of claim 7, wherein said at least one wedge surface comprises an upper wedge surface and a lower wedge surface.
